(19) United States
(12) Patent Application Publication
(10) Pub. No.: US 2009/0263583 A1
(43) Pub. Date: Oct. 22, 2009

(54) SCRATCH OFF DOCUMENT AND METHOD OF PRINTING SAME

(75) Inventors: David A. Mantell, Rochester, NY (US); Christopher Jon Regruit, Rochester, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/104,533

(22) Filed: Apr. 17, 2008

(51) Int. Cl. B05D 1/36; B42D 15/00

(52) U.S. Cl. 427/258; 283/72

(57) ABSTRACT

A scratch-off document may include a substrate. The substrate may include a front side and a backside with an information layer on the front side. An information layer may include an indicia component and a noise component. The noise component together with the indicia component may include a plurality of pile heights, and the indicia component may be visible when combined with the noise component. A scratch-off layer is included over the information layer so that the indicia component is not recognizable through the scratch-off layer.

### CROSS-REFERENCE TO RELATED APPLICATIONS

Not applicable.

### STATEMENT REGARDING FEDERALLY SPONSORED RESEARCH

Not applicable.

### NAMES OF PARTIES TO A JOINT RESEARCH AGREEMENT

Not applicable.

### SEQUENCE LISTING

Not applicable.

### BACKGROUND

1. Technical Field

The disclosed embodiments generally relate to the field of printing and more particularly to a scratch-off document and to methods of printing a scratch-off document.

2. Description of the Related Art

Scratch-off type documents are used in many applications. For example, instant lottery tickets are printed with data that are covered by a scratch-off material. When the scratch-off material is removed by rubbing with a coin, fingernail, or other object, the data under the scratch-off coating are revealed. In addition to lotteries, other such documents are often used for other games, such as retail store contests or product giveaways.

The production of scratch-off documents involves a complex printing application, requiring high volume, low cost printing, and numerous areas of variable data. Areas of variable data include, for example, winning indicia, number marking, and bar code generation. It may also require a release coating and removable scratch-off printing for the scratch-off layer. The scratch-off material in a scratch-off document must adhere to the base material sufficiently so that it does not rub off in ordinary handling, but so that it is easy to rub off with a scratching object such as a coin or fingernail. Scratch-off documents are traditionally produced using a preprinted document in which a wax-like coating or film is applied over the data that is desired to be hidden. The application of wax-like coatings requires the use of additional or specialized hardware, thus increasing the costs and maintenance associated with producing the scratch-off ticket. In addition, due to ink level heights, or pile heights, winning indicia may be discernable through an insufficient scratch-off layer. A scratch-off layer needs to conceal any differences in ink level heights between the background print and the winning indicia.

The complexity of the printing processes and associated cost requirements for producing scratch-off tickets makes the production of scratch-off tickets economically feasible for only large volume games of chance or promotions. Printing of scratch-off tickets for customized, low volume consumer usage, such as for small business promotions (mailers), fundraisers for charity events, family reunions, golf tournaments, and bachelorette parties, for example, is cost prohibitive.

An apparatus and method for printing a scratch-off document that includes a print engine with a multi-color print head and a pile height leveling ink delivery system is disclosed in U.S. patent application Ser. No. 11/565,270, which is incorporated by reference herein in its entirety. A scratch-off document with a removably affixed toner layer is disclosed in U.S. patent application Ser. No. 11/421,251, which is incorporated by reference herein in its entirety.

The disclosure contained herein describes attempts to address one or more of the problems described above.

### SUMMARY

In an embodiment, a scratch-off document may include a substrate that has a front side and a backside. An information layer may be included on the front side. An information layer may include an indicia component and a noise component. Together, the noise component and the indicia component comprise a plurality of pile heights. In an embodiment, the indicia component may be visible when combined with the noise component. A scratch-off layer may be included over the information layer, so that the indicia component is not recognizable through the scratch-off layer.

In an embodiment, the information layer may include a toner. In another embodiment, information layer may include a halftone print.

An embodiment may include an indicia component that includes a plurality of indicia pile heights. In some embodiments, the noise component may include one or more of a dithered ink or an overlapping ink. In an embodiment, a scratch-off layer may include phase-change ink or solid ink.

In an embodiment, the indicia component and the noise component may include a plurality of non-inked substrate areas. In yet another embodiment, the scratch-off layer may include a substantially transparent layer adjacent to the information layer and a substantially opaque layer over the substantially transparent layer. A portion of the substantially transparent layer may be in contact with at least a portion of the non-inked substrate areas. In an embodiment, a scratch-off document may include an infrared security component.

A method embodiment may include printing an information layer on a substrate, which may include printing an indicia component and printing a noise component. Printing the noise component and printing the indicia component may include printing a plurality of pile heights where the indicia component is optically visible in combination with the noise component. In an embodiment, a scratch-off layer may be printed so that the indicia component is not recognizable through the scratch-off layer.

An embodiment of printing the information layer may include electrostatographic printing. In still another embodiment, printing of the information layer may include halftone printing. In an embodiment, printing the indicia component may include printing a plurality of indicia pile heights.

An embodiment may include printing of the scratch-off layer using a phase-change ink. In still another embodiment, printing a scratch-off layer may include printing a substantially transparent layer adjacent to the information layer and a substantially opaque layer over the substantially transparent layer. In an embodiment, the printing of the information layer may result in a plurality of non-inked substrate areas. In yet another embodiment, printing the scratch-off layer may include printing a substantially transparent layer adjacent to the information layer and a substantially opaque layer over the substantially transparent layer, where a portion of the substantially transparent layer is in contact with at least a portion of the plurality of non-printed substrate areas.

An embodiment may include electrostatographically printing an information layer on a substrate, including electrostatographically printing a halftone indicia component and electrostatographically printing a halftone noise component. In an embodiment, printing the noise component together with printing the indicia component may include printing a plurality of pile heights, and printing so that the indicia component is optically visible in combination with the noise component. An embodiment may include printing a removable scratch-off layer with phase-change ink so that an indicia component is not recognizable under the removable scratch-off layer.

An embodiment may include printing the noise component printing the indicia component or both using one or more of dithered ink or overlapping ink. In still another embodiment, printing the noise component together with printing the indicia component may result in a plurality of non-inked substrate areas.

An embodiment may include printing a scratch-off layer. An embodiment of printing a scratch-off layer may include printing a substantially transparent layer adjacent to the information layer and a substantially opaque layer over the substantially transparent layer. In an embodiment, printing of a substantially transparent layer may include printing a portion of the ink from the substantially transparent layer so that it is in contact with at least a portion of the non-inked substrate areas.

### BRIEF DESCRIPTION OF THE DRAWINGS

FIG. 1 is a schematic depiction of a prior art scratch-off ticket.

FIG. 2 depicts an embodiment of a scratch-off ticket without a scratch-off layer.

FIG. 3 depicts an embodiment of a scratch-off ticket with a scratch-off layer.

FIG. 4 schematically depicts a method of printing a scratch-off document using a halftone printing method.

FIG. 5 depicts a flow diagram of an embodiment of a method to print a scratch-off ticket.

FIG. 6A depicts a non-limiting embodiment of an IR readable misleading information security component used in a scratch-off ticket.

FIG. 6B depicts a non-limiting embodiment of a scratch-off ticket with a backside IR absorbing security component.

### DETAILED DESCRIPTION

Before the present methods, systems, and materials are described, it is to be understood that this disclosure is not limited to the particular methodologies, systems, and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

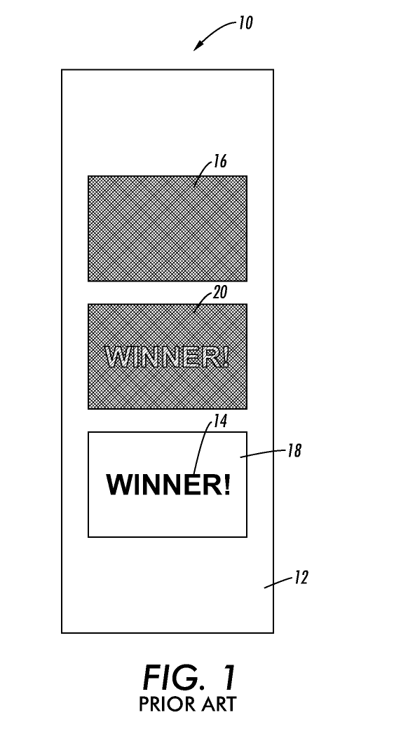

A basic depiction of a prior art scratch-off document 10 is presented in FIG. 1. A scratch-off document may include a substrate 12. The substrate 12 material of construction may be paper, cardboard, plastic, or other material. Printed onto the substrate 12 are one or more messages or indicia 14 that indicate the result of contest, lottery, other promotion, or other information that needs to be concealed. A removable scratch-off layer 16 is provided to conceal the indicia 14 until the consumer or contestant, herein collectively referred to as “contestant”, scratches off the removable scratch-off layer 16 to reveal the indicia 14 and determine the concealed content.

The removable scratch-off layer 16 must be substantially opaque so that the indicia 14 are not optically visible underneath the scratch-off layer 16. However, a contestant may still be able to discern the indicia 14 underneath the removable scratch-off layer 16 due to the differences in thicknesses of different color inks, referred to herein interchangeably as “pile heights” or “level heights” For example, black ink may be thicker than other colors. A contestant may be able to observe the pile height difference underneath the scratch-off layer 16, and thus discern the indicia 14 when the indicia are printed in black and the background 18 is printed in other colors, for example. The result of a pile height difference between the indicia 14 and a background 18 is schematically depicted as reference number 20 in FIG. 1. Also, alignment differences of the ink drops may increase overlap at certain points between black and other colors and may tend to raise edges that can become visible pile height differences.

Additionally, a high level of adhesion between the ink of the indicia 14 and the material of the scratch-off layer 16 may be deleterious to the performance of a scratch-off ticket 10. The removable scratch-off layer 16 may not be able to be completely removed by the contestant. A contestant may damage or remove the indicia 14 in an attempt to remove the scratch-off layer 16.

As used herein, the word “ink” generally includes phase-change ink, toners, oil based liquid ink, water based liquid ink, and any ink material known now of hereafter to a person of ordinary skill in the art. The terms “solid ink” and “phase change ink” are used interchangeably herein and refer to ink that starts off as a waxy block, is momentarily melted for ink-jet ejection, and then re-solidifies on a sheet or substrate. The terms “scratch-off document” and “scratch-off ticket” are used interchangeably herein.

As used herein, the words and phrase “printing”, “printer”, and “print engine” are meant to include direct ink printing and offset printing. Direct ink printing further includes direct solid ink/phase-change ink printing, where the ink is originally in solid form and is melted for printing; direct inkjet printing with oil and/or water based inks; and any other direct printing method known now or hereinafter by a person of ordinary skill in the art. In an embodiment, printing herein may include electrostatographic printing techniques, or electrostatography, that rely on electrostatic forces to transfer ink to the print substrate. In an embodiment, an electrostatographic technique may include, but is not limited to, xerography in which a dry toner is used as the printing medium. In an embodiment, phase-change ink may be momentarily melted for ink-jet injection, and re-solidified on the paper or other printable substrate.

Offset print engines are also included in embodiments herein. Offset print engines are those where the ink or toner is applied to a drum, belt, or other substrate, and then transferred to the paper or material to he printed. Offset print engines include xerographic, laser, light emitting diode (LED), offset solid ink, offset inkjet, offset lithography presses, and any other offset printing method known now or hereinafter to a person of ordinary skill in the art. It is recognized that any combination of print engines are within the scope of the embodiments herein.

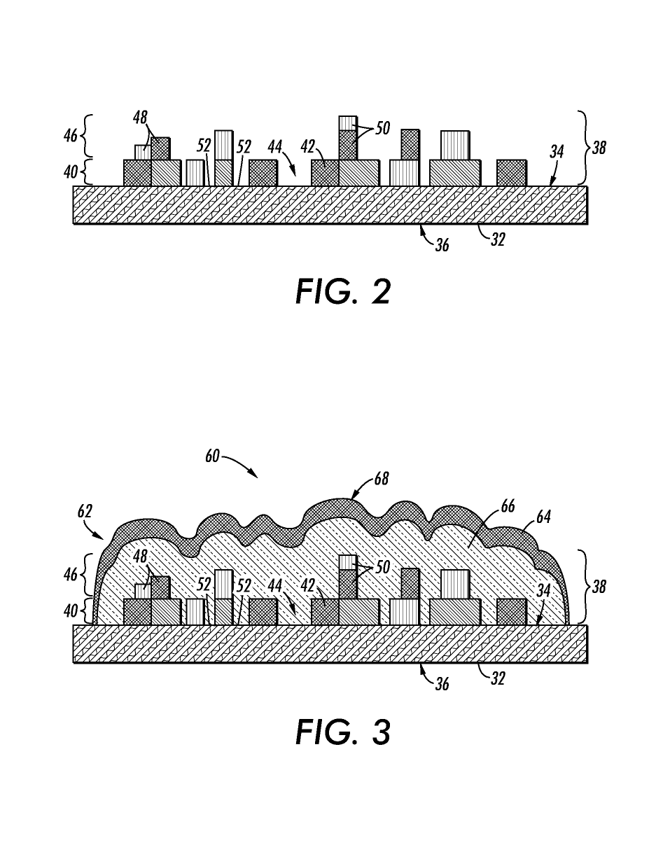

A cross-section of a scratch-off document without a scratch-off layer, of a non-limiting embodiment of this disclosure, is depicted in FIG. 2. A scratch-off document may include a substrate 32 of paper, cardboard, plastic, or any suitable material. The substrate 32 may have a front side 34 and a backside 36. An information layer 38 may be included on the front side 34. An information layer may include an indicia component 40 that may include a plurality of inked areas 42 and a plurality of non-printed areas 44. When viewed directly by a contestant, the indicia component 40 presents a recognizable message analogous to prior art indicia (see for example, indicia 14 in FIG. 1).

In an embodiment, a noise component 46 may be included. A noise component 46 may include one or more of a dithered ink 48 or an overlapping ink 50. In an embodiment, the indicia component 40 may include or more of a dithered ink or an overlapping ink. In yet another embodiment, the indicia component 40 and the noise component 46 may include or more of a dithered ink or an overlapping ink. In an embodiment, a noise component 46 may contain background information, such as for example background colors, patterns, designs, and the like. In an embodiment depicted in FIG. 2, the indicia component 40 is adjacent to the substrate 32, and the noise component 46 is over the indicia component 40. In another embodiment, the indicia component 40 may be over the noise component 46, and the noise component 46 may be adjacent to the substrate 32. In still another embodiment, the indicia component 40 may be embedded within the noise component 46 such that elements of each component may be adjacent to the substrate 32. Any arrangement of indicia component 40 and noise component 46 is encompassed herein, as long as the indicia component 40 of the information layer 38 is optically visible when the indicia component 40 and the noise component 46 are both included in the information layer 38.

The cross hatching of the depictions of inks of the noise component 46 and in the indicia component 40 in FIG. 2 represent different colors of ink, for example, but not limited to, cyan, magenta, and yellow, which are present in a cyan, magenta, yellow, and black (CMYK) method of printing. In an embodiment, different color inks may be used in the noise component 46. In an embodiment, different color inks may be used in the indicia component 40. In another embodiment, different color inks may be used in both the indicia 40 and the noise component 46. Also, and not to be limiting, the inked areas 42 of the indicia component 40 are depicted to be thicker than the inks 48, 50, so as to represent a thicker black ink that may be used to print the indicia component 40. All colors and combinations of inks for the indicia component 40 and for those in the noise component 46 are encompassed in embodiments herein, including inks for printer color spaces that are known now or hereafter to a person of ordinary skill in the art.

In an embodiment, after the printing of the information layer 38, there may be non-inked substrate areas 52 of the substrate 32. Non-inked substrate areas 52 are those that are not covered with ink of the noise component 46 or with ink from the indicia component 40.

In an embodiment, the combined pile heights of the noise component 46 and the indicia component 40 may include a plurality of pile heights. A plurality of pile heights of the combined noise component 46 and the indicia component 40 may prevent a person from detecting the indicia component 40 through a scratch-off layer (not shown), which would be printed over the information layer 38, for example, as depicted in the prior art of reference number 20 in FIG. 1. In an embodiment, the indicia component 40 may be visible as a distinct color or shade when combined with the noise component 46.

Referring now to FIG. 3, an embodiment of a scratch-off ticket 60 may include a scratch-off layer 62 over the information layer 38, where the indicia component 40 of the information layer 38 is not recognizable through the scratch-off layer 62. An embodiment may include a scratch-off layer 62 that includes a substantially opaque component 64 and a substantially transparent component 66. In an embodiment, a substantially transparent component 66 may be optional. The phrase “substantially transparent” is used herein to mean that the indicia component 40 is visible and can be interpreted or read by a contestant through the substantially transparent component 66. A substantially transparent component 66 may include, but is not limited to one or more of yellow ink, magenta ink, or clear ink.

In an embodiment, the scratch-off layer 62 may include an image, a message, a graphic, a design, or other marking, collectively referred to herein as an “image”, printed on an area 68 facing away from the substrate 32. A message on a scratch-off layer 62 may include for example, but is not limited to, “Scratch Here”. An image may be visible based on one or more of color, raised or lowered regions, or texture differences.

In an embodiment, a substantially transparent component 66 of a scratch-off layer 62 may contact the non-inked substrate areas 52 corresponding to non-printed areas 44 of the indicia component 40 that may be present after printing the information layer 38, and may result in a certain degree of adhesion between the substantially transparent component 66 and the non-inked substrate areas 52. In an embodiment, the substantially transparent component 66 may not be entirely removed when a contestant scratches the scratch-off layer. The adhered substantially transparent component 66 may prevent the indicia component 40 from being damaged during the scratching procedure.

In an embodiment where the scratch-off layer 62 includes solid ink, a thicker layer of solid ink used in the scratch-off layer may be easier to scratch off, or require less scratching force, than a thinner layer of solid ink used in a scratch-off layer 62. In an embodiment, a scratch-off layer 62 may not be entirely removed by a contestant. In an embodiment when a scratch-off layer 62 includes a substantially opaque component 64 and a substantially transparent component 66, the substantially opaque component 64 may be at least mostly removed during scratching, while the substantially transparent component 66 may be partly left behind. A scratch-off layer 62 with a substantially transparent component 66 may improve the visibility of the indicia component 40 in a case of incomplete removal of a scratch-off layer 62.

In another embodiment, the adhesion of a substantially transparent component 66 of a scratch-off layer 62 to a substrate 32 may be controlled by controlling the total area of the non-inked substrate areas 52 present after printing the information layer 38. In an embodiment, increasing the total area of the non-inked substrate areas 52 may increase the adhesion of the substantially transparent component 66 of the scratch-off layer 62 to the substrate 32. Alternatively, the substantially transparent component 66 of the scratch-off layer 62 may be formulated so that it does not adhere well to the substrate material. In an embodiment, increasing the total area of non-inked areas 52 may decrease the adhesion of the substantially transparent component 66 of the scratch-off layer 62 to the substrate 32, and the adhesion may be increased by decreasing the total area of non-inked substrate areas 52. A person of ordinary skill in the art could determine, without undue experimentation, the total area of the non-inked substrate areas 52 required for a desired degree of adhesion of a substantially transparent component 66 of a scratch-off layer 62 to a substrate 32.

In an embodiment, a scratch-off layer 62 may include a solid ink, also referred to as a phase-change ink and an information layer 38 may include an electrostatographic toner. In an embodiment, the information layer 38 may include one or more of electrostatographic toner, solid ink, oil based liquid ink, water based liquid ink, or any ink material known now of hereafter to a person of ordinary skill in the art.

In another embodiment, the indicia component 40 may include a halftone print. In still another embodiment, the noise component 46 may include a halftone print. One embodiment may include an indicia component 40 that further includes a plurality of indicia pile heights (not depicted in the FIGs.). In yet another embodiment a noise component 46 may cover at least a portion of the non-printed areas 44 of the indicia component 40.

Depending upon the colorants in the ink that are used for a scratch-off ticket 60, it may be possible to observe an indicia component 40 through a scratch-off layer 62 by using infrared (IR) illumination. For example, a black electrostatographic toner may be used to print the indicia component 40 and a black solid ink may be used as a scratch-off layer 62. The black solid ink may use dyes as colorants, whereas the toner may use carbon black as a colorant. Carbon black may absorb IR radiation better than the dyes in the solid ink, which may allow an indicia component 40 with carbon black containing toner to be detected with IR illumination through a scratch-off layer 62 containing dyes and no carbon black. An embodiment may include a security component (not shown) that is capable of being discerned with infrared illumination through the scratch-off layer. The security component may contain false information intended to be detected by IR illumination, and confuse a person attempting to see the indicia component 40 using IR illumination prior to removing a scratch-off layer 62. Alternatively, an IR absorbent material may be deposited on the backside 36 of a scratch-off ticket so that the IR absorption by the indicia component 40 is not detected, or “drowned out”, due to the absorption of the IR absorbing material on the backside 36. Alternatively, an ink containing carbon black or other IR absorptive material may be used in the scratch-off layer 62.

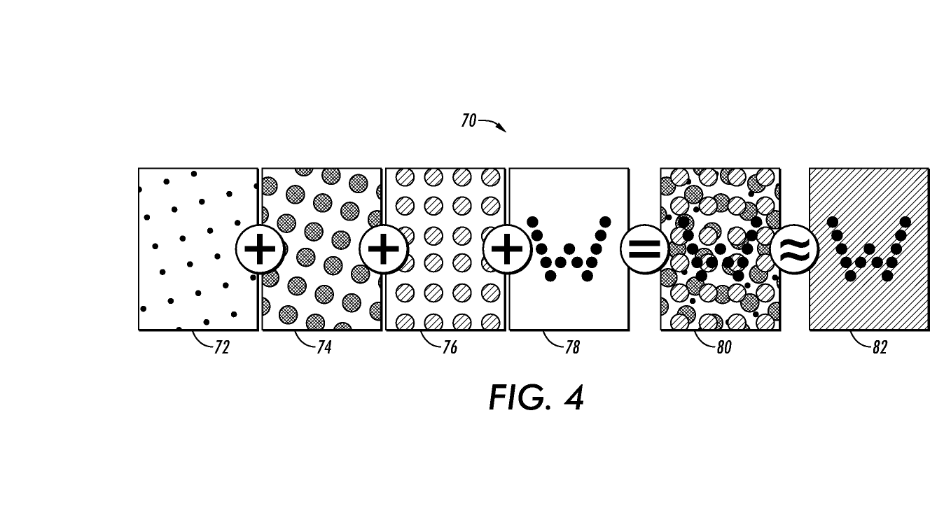

Referring now to FIG. 4, a non-limiting embodiment of printing a scratch-off ticket may include halftone printing 70. As understood in the art, halftone printing is a printing technique that simulates continuous tone imagery by using dots or other patterned elements of similar or varying size. An embodiment may include black and white or grayscale halftone printing. Another embodiment may include color halftone printing. In color halftone printing, different colors and sizes of dots may be used. As mentioned hereinabove, and not meant to be limiting, an embodiment may include different colors of ink in a four-color CMYK process that uses cyan, magenta, and yellow as the primary colors, plus black. As schematically depicted in FIG. 4, an embodiment of halftone printing 70 may include printing a first background color 72, printing a second background color 74, and printing a third background color 76. Indicia 78 may be printed in another color. Microscopically, the resulting print may appear as schematically depicted by reference number 80. At a distance, however, in an embodiment, the contestant may visualize the background colors 72, 74, and 76 as a single color as schematically depicted by reference number 82. Since the indicia 78 may be printed in a different color than the background colors 72, 74, 76, the indicia 78 is visible to a contestant with respect to the background colors 72, 74, and 76. In another embodiment, the contestant may visualize the background colors 72, 74, and 76 as a design, graphic, or the like that may include more than one macroscopically visualized color, and the contestant may still visibly recognize the indicia 78 and the color of the indicia with respect to the background colors 72, 74, and 76.

In an embodiment, the background colors 72, 74, and 76 together with the ink of the indicia 78 may provide a plurality of pile heights. A plurality of pile heights may prevent a contestant from discerning the indicia 78 before scratching off a scratch-off layer that is applied over the background colors 72, 74, and 76 and the ink of the indicia 78. In another embodiment, the inks of the background colors and/or 72, 74, and 76 and the ink of the indicia 78 may be dithered or overlapped.

In an embodiment, the background colors 72, 74, and 76 may be referred to as a noise layer as described hereinabove, and schematically depicted in FIGS. 2 and 3 as reference number 46. In another embodiment, the background or noise 72, 74, and 76 may be printed for example with yellow, magenta, and red, where the indicia 78 may be printed with one or more of cyan, green, or blue.

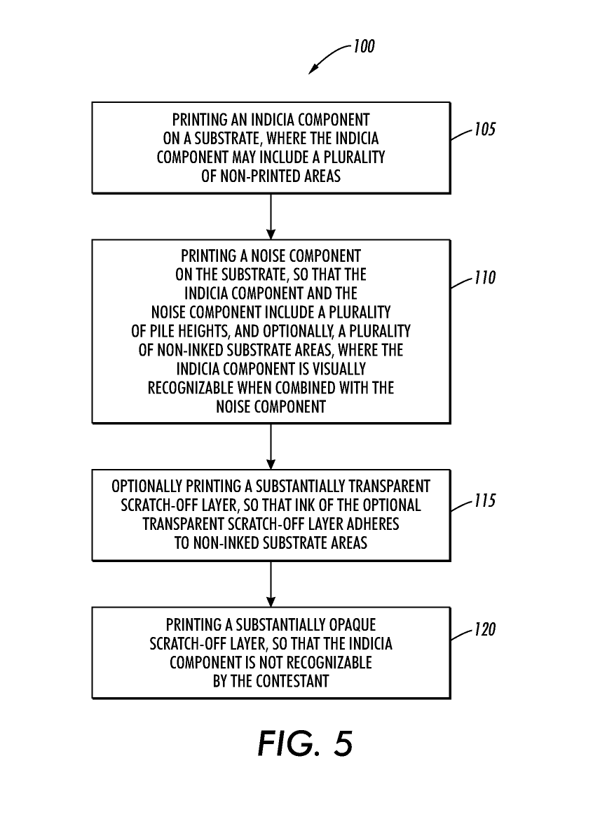

In an embodiment charted in FIG. 5, a method for printing a scratch-off document 100 may include printing an information layer on a substrate, where printing the information layer includes printing an indicia component 105 and printing a noise component 110. For embodiments herein, the indicia component may be printed before, after, at the same time, or in between printing the noise component. In an embodiment, printing the indicia component 105 may include printing a plurality of printed areas and a plurality on non-printed areas. In another embodiment, printing the noise component 110 may include printing one or more of dithered ink or overlapping ink. In an embodiment printing the information layer on a substrate may include printing a noise component 110 and an indicia component 105 so that the combination of the noise component 110 and the indicia component 105, referred to herein as the information layer (see ref. no. 38 on FIGS. 2 and 3) includes a plurality of pile heights. In an embodiment, printing the indicia component 105 and printing the noise component 110 may be done so that the indicia component has a color or shade that may be optically discerned or recognized by a contestant, after the indicia component and the noise component are printed.

In an embodiment, printing the indicia component 105 and printing the noise component 110 (also referred to herein as the background) may include electrostatographic printing process or a xerographic printing process. In an embodiment, a toner or electrostatographic toner may be used to print the indicia component 105 and/or the noise component 110. In general, a toner may include electrostatically charged powders that include a pigment and a plastic. In a xerographic process, the toner is attracted to the printable material because of differences in electrostatic charge between the toner and the printable material, which may include paper or other materials. Toner particles that were attracted to the paper may then be melted by a fusing process, which causes that plastic and pigment to diffuse into the fibers of the paper. This can result in a smudge resistant print, and the total process may be referred to interchangeably as an electrostatographic or xerographic printing process.

An embodiment of printing the indicia component 105 and the noise component 110 may include halftone printing. Any printing process known now or hereinafter to a person of ordinary skill in the art that can achieve a visually recognizable indicia after printing the indicia component 105 and printing the noise component 110, and provides a plurality of pile heights for the combination of the indicia component and the noise component are within the scope of embodiments herein.

An embodiment may optionally include printing a substantially transparent scratch-off layer 115 after printing the indicia component 105 and printing the noise component 110. Printing the optional substantially transparent scratch-off layer 115 may include printing to non-inked substrate areas, which were free of ink after printing the indicia component 105 and printing the noise component 110. This may provide a method for adjusting the degree of adhesion of the optional substantially transparent scratch-off layer to the substrate, as discussed hereinabove (see ref. no. 52 in FIG. 3).

Another embodiment may include printing a substantially opaque scratch-off layer 120 so that the indicia component cannot be seen through the substantially opaque scratch-off layer. The opaque scratch-off layer, together with the plurality of combined pile heights of the indicia component and the noise component, render the indicia component unrecognizable to an ordinary contestant before the contestant scratches off the substantially opaque scratch-off layer.

In embodiments, where an unscrupulous contestant may attempt to discern the indicia component through the substantially opaque scratch-off layer using infrared (IR) equipment, optional steps may include printing an infrared security component. A security component may include, but is not limited to, one or more of misleading information that is visible or readable with IR radiation, a backside printed with IR absorbing material to “drown-out” IR absorbing material in the indicia component, a scratch-off layer printed with IR absorbing material, and an indicia component printed with ink that does not contain IR absorbing material.

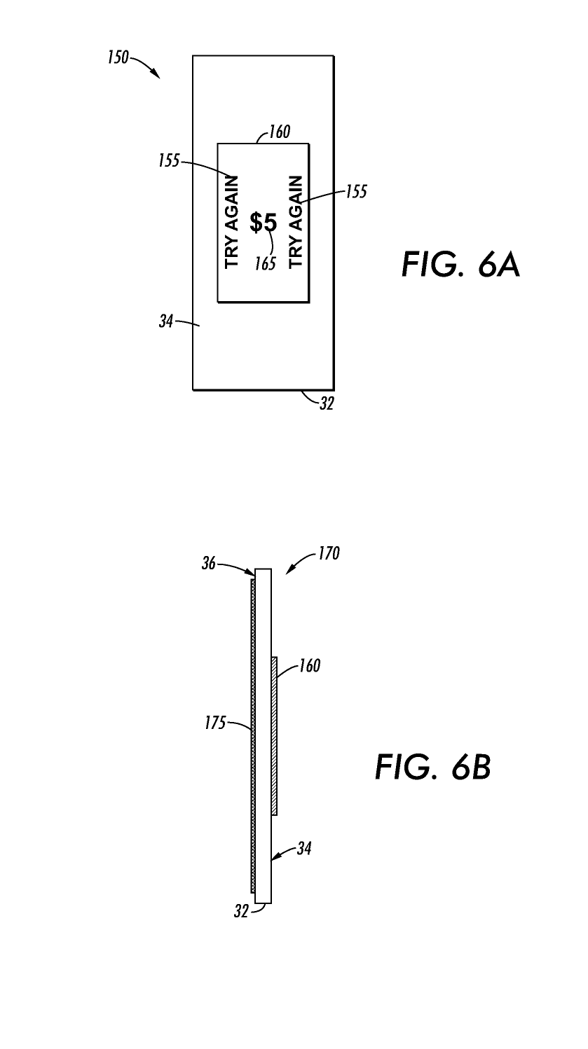

FIG. 6A depicts a non-limiting embodiment of an IR readable misleading information security component used in a scratch-off ticket 150. IR readable misleading information 155 may be printed on the front side 34 of a substrate 32 in scratch-off area 160. The IR readable misleading information 155 may be printed away from critical information or winning indicia 165 in an attempt to hide the winning indicia 165.

FIG. 6B depicts a non-limiting embodiment of a scratch-off ticket with a backside IR absorbing security component 170. In an embodiment, a scratch-off ticket with a backside IR absorbing security component 170 may include a substrate 32 with a front side 34 and a backside 36. The front side may contain a scratch-off area 160 that may include winning or losing indicia or other critical information (not shown) that contain IR absorbing ink. In an embodiment, an IR absorbing material 175 may be printed on the backside 36 of the substrate 32. In an embodiment not shown in FIG. 6B, the IR absorbing material 175 may be printed only on an area of the backside 36 corresponding to scratch-off area 160 of the front side 34. In another embodiment (not shown), the IR absorbing material may be at least partially printed on the backside in a manner that results in the IR absorbing material effectively camouflaging or “drowning out” any signature from IR absorbing material in the ink of the indicia (not shown). In still another embodiment (not shown), an IR absorbing material may be printed on the front-side over a scratch-off layer.

An embodiment may include electrostatographically printing an information layer on a substrate, which may include electrostatographically printing a halftone indicia component and electrostatographically printing a halftone noise component. Printing the noise component may include printing one or more of dithered ink or overlapping ink. Printing the noise component together with printing the indicia component may include printing a plurality of pile heights, and may include an embodiment where the indicia component is optically visible in combination with the noise component. An embodiment may include solid ink printing a removable scratch-off layer, wherein the indicia component is not recognizable under the removable scratch-off layer.

In another embodiment, printing the noise component together with printing the indicia component may result in a plurality of non-inked substrate areas. In still another embodiment, printing of the scratch-off layer may include printing a substantially transparent layer adjacent to the information layer and a substantially opaque layer over the substantially transparent layer. A portion of an ink from the substantially transparent layer may be printed to be in contact with the plurality of non-inked substrate areas.

Solid ink compositions are known. In an embodiment, a solid ink may comprise Phaser 8500/8550—Solid Ink from the Xerox® Corporation. For example, but not limited to, solid ink compositions are disclosed in U.S. Pat. No. 6,906,118, the disclosure of which is totally incorporated herein by reference. U.S. Pat. No. 6,906,118 discloses solid inks that include hydrogen bonded dimers, oligomers, or polymers. U.S. Pat. No. 6,306,203, the disclosure of which is totally incorporated herein by reference, discloses a solid ink-based that includes non-polymeric ester compound ink vehicles. U.S. Pat. App. Pub. No. 20060132570, the disclosure of which is totally incorporated herein by reference, discloses a solid ink with a radiation curable oil soluble compound.

In an embodiment, the electrostatographic toner used for the information layer may comprise iGen3® Digital Production Press—Bulk Toner from the Xerox® Corporation. The information layer may alternatively include any other toner material familiar to those of ordinary skill in the art.

Toner compositions are known, such as those disclosed in U.S. Pat. No. 4,543,313, the disclosure of which is totally incorporated herein by reference. In U.S. Pat. No. 4,891,293, the disclosure of which is totally incorporated herein by reference, there are disclosed toner compositions with thermotropic liquid crystalline copolymers, and wherein sharp melting toners are illustrated. Moreover, in U.S. Pat. No. 4,973,539, the disclosure of which is totally incorporated herein by reference, there are disclosed toner compositions with crosslinked thermotropic liquid crystalline polymers.

Low fixing toners comprised of semicrystalline resins are also known, such as those disclosed in U.S. Pat. No. 5,166,026, the disclosure of which is totally incorporated herein by reference, and wherein toners comprised of a semicrystalline copolymer resin, such as poly(alpha-olefin) copolymer resins, with a melting point of from about 30° C. to about 100° C., and containing functional groups comprising hydroxy, carboxy, amino, amido, ammonium or halo, and pigment particles, are disclosed. Similarly, in U.S. Pat. No. 4,952,477, the disclosure of which is totally incorporated herein by reference, toner compositions comprised of resin particles selected from the group consisting of semicrystalline polyolefin and copolymers thereof with a melting point of from about 50° C. to about 100° C., and containing functional groups comprising hydroxy, carboxy, amino amido, ammonium or halo, and pigment particles, are disclosed. Similarly, in U.S. Pat. No. 4,952,477, the disclosure of which is totally incorporated herein by reference, toner compositions comprised of resin particles selected from the group consisting of semicrystalline polyolefin and copolymers thereof with a melting point of from about 50° C. to about 100° C. and pigment particles are disclosed. In U.S. Pat. No. 4,990,424, the disclosure of which is totally incorporated herein by reference, toners including a blend of resin particles containing styrene polymers or polyesters, and components selected from the group consisting of semicrystalline polyolefin and copolymers thereof with a melting point of from about 50° C. to about 100° C. are disclosed. Fusing temperatures of from about 250° F. to about 330° F. (degrees Fahrenheit) are reported.

Low fixing crystalline-based toners are disclosed in U.S. Pat. No. 6,413,691, the disclosure of which is totally incorporated herein by reference, and wherein a toner including a binder resin and a colorant, the binder resin containing a crystalline polyester containing a carboxylic acid of two or more valences having a sulfonic acid group as a monomer component, is illustrated. The crystalline resins of the '691 patent are believed to be opaque, resulting in low projection efficiency.

Crystalline-based toners are disclosed in U.S. Pat. No. 4,254,207, the disclosure of which is totally incorporated herein by reference. Low fixing toners comprised of crosslinked crystalline resin and amorphous polyester resin are illustrated in U.S. Pat. No. 5,147,747 and U.S. Pat. No. 5,057,392, the disclosures of which are totally incorporated herein by reference, and wherein the toner powder is comprised, for example, of polymer particles of partially carboxylated crystalline polyester and partially carboxylated amorphous polyester that have been crosslinked together at elevated temperature with the aid of an epoxy novolac resin and a crosslinking catalyst.

Also of interest are U.S. Pat. Nos. 6,383,205; 6,017,671; and 4,385,107, the disclosures of which are totally incorporated herein by reference. U.S. Patent Pub. No. 2004/0142266, herein incorporated by reference in its entirely, describes a toner comprised of a branched amorphous sulfonated polyester resin, a crystalline sulfonated polyester resin, a colorant, and an optional wax. In the toner of the '266 Publication, the crystalline resin displays or possesses a melting temperature of from about 50° C. to about 110° C.; the amorphous branched resin has an average molecular weight of about 2,000 to about 300,000 grams per mote; and the crystalline resin displays an average molecular weight of about 1,000 to about 50,000 grams per mole.

U.S. Pat. No. 6,500,594, herein incorporated by reference in its entirety, describes an electrophotographic developer comprising a toner and a carrier, wherein the toner contains a colorant and a crystalline resin, and wherein the carrier has a nitrogen-containing resin coating. The toner of the '594 Patent preferably has specific Theological properties including certain dynamic viscosity characteristics. The toner has a storage elastic modulus (G′) of 1×10⁶ Pa or more and a loss elastic modulus (G″) of 1×10⁶ Pa or more at the angular frequency of 1 rad/sec and at 30° C. The elastic properties are related to toner hardness, stability, and fusing temperature. U.S. Pat. Nos. 6,582,896 and 6,607,864, herein incorporated by reference in their entirety, also describe toners having similar rheological characteristics.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the an which are also intended to be encompassed by the following claims.

What is claimed is:

1. A scratch-off document, comprising
a substrate comprising a front side and a backside;
an information layer on the front side, comprising:
an indicia component; and
a noise component;
wherein the noise component together with the indicia component comprise a plurality of pile heights;
wherein the indicia component is visible when combined with the noise component; and
a scratch-off layer over the information layer, wherein the indicia component is not recognizable through the scratch-off layer.

2. The document of claim 1 wherein the information layer comprises a toner.

3. The document of claim 1, wherein information layer comprises a halftone print.

4. A the document of claim 1, wherein the noise component comprises one or more of a dithered ink or an overlapping ink.

5. The document of claim 1, wherein the scratch-off layer comprises a phase-change ink.

6. The document of claim 1, wherein the scratch-off layer comprises a substantially transparent layer adjacent to the information layer and a substantially opaque layer over the substantially transparent layer.

7. The document of claim 1, wherein the information layer comprises a plurality of non-inked substrate areas; wherein the scratch-off layer comprises a substantially transparent layer adjacent to the information layer and a substantially opaque layer over the substantially transparent layer; and wherein a portion of the substantially transparent layer is in contact with at least a portion of the plurality of non-inked substrate areas.

8. The document of claim 1, wherein the scratch off layer comprises an image.

9. The document of claim 1, further comprising an infrared security component.

10. A method, comprising:
printing an information layer on a substrate, comprising printing an indicia component and printing a noise component;
wherein printing the noise component and printing the indicia component comprise printing a plurality of pile heights, and wherein the indicia component is optically visible in combination with the noise component; and
printing a scratch-off layer, wherein the indicia component is not recognizable through the scratch-off layer.

11. The method of claim 10, wherein the printing of the information layer comprises electrostatographic printing.

12. The method of claim 10, wherein the printing of the information layer comprises halftone printing.

13. The method of claim 10, wherein printing the indicia component comprises printing a plurality of indicia pile heights.

14. The method of claim 10, wherein the printing of the scratch-off layer comprises phase-change ink printing.

15. The method of claim 10, wherein printing the scratch-oft layer comprises printing a substantially transparent layer adjacent to the information layer and a substantially opaque layer over the substantially transparent layer.

16. The method of claim 10, wherein printing of the information layer results in a plurality of non-inked substrate areas; and wherein printing the scratch-off layer comprises printing a substantially transparent layer adjacent to the information layer and a substantially opaque layer over the substantially transparent layer; and wherein a portion of the substantially transparent layer is in contact with at least a portion of the plurality of non-inked substrate areas.

17. A method, comprising:
electrostatographically printing an information layer on a substrate, comprising:
electrostatographically printing a halftone indicia component and electrostatographically printing a halftone noise component;
wherein printing the noise component together with printing the indicia component comprise printing a plurality of pile heights, and wherein the indicia component is optically visible in combination with the noise component; and
phase-change ink printing a removable scratch-off layer, wherein the indicia component is not recognizable under the removable scratch-off layer.

18. The method of claim 17, wherein one or more of printing the noise component or printing the indicia component comprises printing one or more of dithered ink or overlapping ink.

19. The method of claim 17, wherein printing of the scratch-off layer comprises printing a substantially transparent layer adjacent to the information layer and a substantially opaque layer over the substantially transparent layer.

20. The method of claim 17, wherein printing the information layer comprises printing that results in a plurality of non-inked substrate areas; and where printing the scratch-off layer comprises printing a substantially transparent layer adjacent to the information layer and a substantially opaque layer over the substantially transparent layer; wherein an ink from the substantially transparent layer is in contact with at least a portion of the plurality of non-inked substrate areas.
